(19) United States
(12) Patent Application Publication
(10) Pub. No.: US 2025/0376336 A1
(43) Pub. Date: Dec. 11, 2025

(54) GOODS ALIGNMENT SUPPLY EQUIPMENT, AND GOODS ALIGNMENT SUPPLY METHOD

(71) Applicant: TOKUNAGA MANUFACTURING CO., LTD., Osaka (JP)

(72) Inventors: Kosuke TOKUNAGA, Osaka (JP); Tomohiro Mitsuhashi, Osaka (JP); Kohei Ota, Osaka (JP); Satoshi Morino, Osaka (JP)

(21) Appl. No.: 18/958,320

(22) Filed: Nov. 25, 2024

(30) Foreign Application Priority Data
Jun. 11, 2024 (JP) 2024-094747

(51) Int. Cl. B65G 47/14; B65G 47/90

(52) U.S. Cl. CPC B65G 47/14; B65G 47/905; B65G 2203/0225; B65G 2203/044

(57) ABSTRACT

It is a purpose of the present invention to provide goods alignment supply equipment that can improve the feeding capacity of goods from a rotary alignment apparatus to a conveyor device, comprising: a rotary alignment apparatus that aligns goods while rotating; a visual sensor that recognize the goods that have been aligned using the rotary alignment apparatus; a transfer robot that transfers the goods recognized by the visual sensor to a conveyor; and a controller that controls rotational alignment operation of the goods by the rotary alignment apparatus and transfer operation of the goods by the transfer robot in an integrated manner, obtaining recognition information for the goods from the visual sensor.

### TECHNICAL FIELD

The present invention relates to a goods alignment supply equipment and goods alignment supply method, and more particularly, to a goods alignment supply equipment and goods alignment supply method which is able to supply goods such as containers supplied in pieces to a conveyor in a predetermined posture.

### BACKGROUND ART

In production lines, when filling containers continuously with liquid products such as food, detergents, or cosmetic products, or powdery or granular products such as food or medicine, the filling operation is often performed with the containers in an upright posture. Therefore, before the filling process, a process is often established to supply the containers to a conveyor or other transfer device in a predetermined posture, such as standing up.

As a device suitable for use in the above process of supplying the goods to a conveyor in a predetermined posture, the applicant has previously proposed a goods alignment supply equipment as described in the following Patent Document 1.

FIG. 14 is a plan view of the main part of the goods alignment supply equipment described in the Patent Document 1. The goods alignment supply equipment 100 is equipped with a rotary alignment apparatus 200 and a picking robot 300.

The rotary alignment apparatus 200 has a accommodation 210 of goods 2 and a goods loading area 240 that places the goods 2 side by side around the perimeter of the top of the accommodation 210.

The picking robot 300 is a robot equipped with holding means that holds the goods 2 located at the goods loading area 240 and performs the operation of placing the goods 2 held by the holding means in a predetermined posture on a conveyor 400 that is in close proximity.

At the goods alignment supply equipment 100, based on the image taken by the imaging device, the process is designed to determine the goods 2 and their positions arranged in the goods loading area 240, and to control the holding of the goods 2 by the picking robot 300 and their transfer to the conveyor 400.

According to the goods alignment supply equipment 100, the goods 2 could be supplied to the conveyor 400 relatively efficiently.

### Problems to Be Solved by the Invention

However, there is some variation in the spacing between the goods 2 placed on the goods loading area 240 at the goods alignment supply equipment 100. Sometimes the goods 2 are aligned with almost no gap between them, while other times the spacing extends over the length of the goods 2.

In the goods alignment supply equipment 100, the operation of the rotary alignment apparatus 200 and the operation of the picking robot 300 are controlled separately.

Therefore, when the distance between the goods 2 placed on the goods loading area 240 widened, the interval between the picking operation of the goods 2 by the picking robot 300 also widened, and the efficiency of supplying the goods 2 to the conveyor 400 was sometimes reduced.

In addition, if the goods 2 continued to be lined up in goods loading area 240 with almost no gaps, the transfer operation by the picking robot 300 could not be completed in time, resulting in the overflow of the goods 2 and reducing the efficiency of supplying the goods 2 to the conveyor 400.

Thus, the goods alignment supply equipment 100 sometimes temporarily decreased the efficiency of supplying the goods 2 to the conveyor 400, and there was room to improve the capacity of supplying the goods 2 from the rotary alignment apparatus 200 to the conveyor 400.

### PRIOR ART DOCUMENT

### Patent Document

Patent Document 1: Japanese Patent Application Laid-Open Publication No. 2019-151441

### SUMMARY OF THE INVENTION

### Solution to Problem and Advantageous Effect of Invention

The present invention was developed in order to solve the above problem, and it is an object of the present invention to provide goods alignment supply equipment and goods alignment supply method that can improve the feeding capacity of goods from a rotary alignment apparatus to a conveyor device.

In order to achieve the above object, a goods alignment supply equipment (1) of the present invention is characterized by comprising:
a rotary alignment apparatus that aligns goods while rotating;
a visual sensor that recognize the goods that have been aligned using the rotary alignment apparatus;
a transfer robot that transfers the goods recognized by the visual sensor to a conveyor; and
a controller that controls rotational alignment operation of the goods by the rotary alignment apparatus and transfer operation of the goods by the transfer robot in an integrated manner, obtaining recognition information for the goods from the visual sensor.

According to the goods alignment supply equipment (1), the rotational alignment operation of the goods by the rotary alignment apparatus and the transfer operation of the goods by the transfer robot are controlled in an integrated manner by the control unit, based on the recognition information of the goods. Therefore, by integrating control by linking the rotational alignment operation of the goods with the transfer operation of the goods, it is possible to synchronize the control of these operations for smoother control and to increase the efficiency of these operations. The ability to supply the goods from the rotary alignment apparatus to the conveyor can be improved.

The goods alignment supply equipment (2) of the present invention is characterized in that, in the above-mentioned the goods alignment supply equipment (1), the goods alignment supply equipment comprises:
a input device that input the goods to the rotary alignment apparatus; and
the controller that controls rotational alignment operation of the goods by the rotary alignment apparatus and input operation of the goods by the input device in an integrated manner according to the first aspect of the present invention.

According to the goods alignment supply equipment (2), furthermore, the rotational alignment operation of the goods by the rotary alignment apparatus and input operation of the goods by the input device are controlled in an integrated manner by the control unit.

Therefore, by integrating control by linking the rotational alignment operation of the goods with the input operation of the goods, it is possible to smoothly and appropriately perform the input operation of the goods according to the state of alignment of the goods in the rotary alignment apparatus, etc., and to optimize the input operation of the goods from the input device to the rotary alignment apparatus.

The goods alignment supply equipment (3) of the present invention is characterized in that, in the above-mentioned the goods alignment supply equipment (1) or (2), the controller controls transfer operation of the goods by the transfer robot and conveyance operation of the goods by the conveyor in an integrated manner.

According to the goods alignment supply equipment (3), the transfer operation of the goods by the transfer robot and the conveyance operation of the goods by the conveyor are controlled in an integrated manner by the control unit.

Therefore, by integrating control by linking the transfer operation of the goods with the conveyance operation of the goods, it is possible to smoothly and appropriately perform the conveyance operation of the goods according to the state of transfer of the goods by the transfer robot, etc., and to optimize the conveyance operation of the goods by the conveyor.

The goods alignment supply equipment (4) of the present invention is characterized in that, in any one of the above-mentioned the goods alignment supply equipment (1)˜(3),
the rotary alignment apparatus comprises:
a outer rotator having outer ring on which the goods can be placed side by side in the direction of rotation;
a inner rotator having inner disk arranged in an inclined posture inside the outer rotator;
the visual sensor having imaging unit for capturing images of a portion area of the outer ring;
the transfer robot having a holder for holding the goods located within a predetermined area of the outer ring;
the controller having the first control that track the goods captured by the imaging unit and change the rotation speed of the outer ring based on the tracking information of the goods in the outer ring, and the second control that track the goods at the outer ring in response to the first control, and control the operation of holding the goods located within the predetermined area of the outer ring by the holder.

According to the goods alignment supply equipment (4), the first control and the second control are executed by the controller. So there are no delays in these controls. Based on the tracking information of the goods in the outer ring, the rotation speed of the outer ring can be changed to track the goods in the outer ring while smoothly executing the operation of holding the goods located in the predetermined area of the outer ring by the holder.

Therefore, even if the state of alignment of the goods in the outer ring is uneven, the operational efficiency of transferring the goods from the rotary alignment apparatus to the conveyor can be improved, and the supply capacity of the goods from the rotary alignment apparatus to the conveyor can be reliably improved.

The goods alignment supply equipment (5) of the present invention is characterized in that, in the above-mentioned the goods alignment supply equipment (4), wherein the predetermined area of the outer ring is divided into multiple areas in the direction of rotation, and the controller, in the first control, determines in which of the multiple areas the tracked goods is located, and controls the switching of the rotation speed of the outer ring according to the determination.

According to the goods alignment supply equipment (5), the controller, in the first control, determines in which of the multiple areas the tracked goods is located, and controls the switching of the rotation speed of the outer ring according to the determination. So the rotation speed of the outer ring can be switched according to the position of the goods in the predetermined area of the outer ring, in the second control, it is possible to equalize or shorten the operating intervals for transferring the goods located within the predetermined area of the outer ring to the conveyor.

The goods alignment supply equipment (6) of the present invention is characterized in that, in the above-mentioned the goods alignment supply equipment (5), wherein the controller, in the first control, switches the rotation speed of the outer ring so that, of the multiple areas, the area upstream of the rotation direction has a higher rotation speed than the area downstream of the rotation direction.

According to the goods alignment supply equipment (6), the controller, in the first control, switches the rotation speed of the outer ring so that, of the multiple areas, the area upstream of the rotation direction has a higher rotation speed than the area downstream of the rotation direction.

In other words, the controller, in the first control, switches the rotational speed of the outer ring so that, of the multiple areas, the area downstream of the rotation direction has a slower rotation speed than the area upstream of the rotation direction.

Therefore, when the tracked goods is located in the upstream area of the rotation direction, the distance between the goods and the holder can be accelerated by setting the rotation speed to a relatively higher value than when the goods is located in the downstream area. Therefore, it is possible to shorten the operating interval for transferring the goods to the conveyor, thereby improving the supply capacity per unit of time.

When the tracked goods is located in the downstream area of the rotation direction, the rotation speed is set to a relatively slower value than when the goods is located in the upstream region, thereby delaying the separation of the distance between the goods and the holder. The spread of operating intervals for transferring the goods to the conveyor can be reduced.

It is possible to securely hold the goods within a predetermined area of the outer ring to prevent transfer leakage (overflow) of the goods, thereby improving the supply capacity per unit of time.

The goods alignment supply equipment (7) of the present invention is characterized in that, in any one of the above-mentioned the goods alignment supply equipment (4)˜(6), wherein the rotary alignment apparatus and the conveyor are located in close proximity to each other, the transfer robot is arranged so that the holder can be positioned downstream of the imaging unit in the direction of rotation of the outer ring and on the area where the rotary alignment apparatus and the conveyor are closest to each other.

According to the goods alignment supply equipment (6), the holder can be moved by the shortest path when transferring the goods from the outer ring to the conveyor with the transfer robot. The transfer time of the goods can be shortened, and the ability to supply the goods to the conveyor can be improved.

A goods alignment supply method (1) of the present invention, wherein
a rotary alignment apparatus aligns the goods in the direction of rotation while rotating them;
a visual sensor recognize the goods that have been aligned using the rotary alignment apparatus;
a transfer robot transfers the goods recognized by the visual sensor to a conveyor; and
a controller controls rotational alignment operation of the goods by the rotary alignment apparatus and transfer operation of the goods by the transfer robot in an integrated manner, obtaining recognition information for the goods from the visual sensor.

According to the goods alignment supply method (1), the rotational alignment operation of the goods by the rotary alignment apparatus and the transfer operation of the goods by the transfer robot are controlled in an integrated manner by the control unit, based on the recognition information of the goods. Therefore, by integrating control by linking the rotational alignment operation of the goods with the transfer operation of the goods, it is possible to synchronize the control of these operations for smoother control and to increase the efficiency of these operations. The ability to supply the goods from the rotary alignment apparatus to the conveyor can be improved.

The goods alignment supply method (2) of the present invention is characterized in that, in the above-mentioned the goods alignment supply method (1), wherein the controller controls rotational alignment operation of the goods by the rotary alignment apparatus and input operation of the goods by a input device that input the goods to the rotary alignment apparatus in an integrated manner.

According to the goods alignment supply method (2), by integrating control by linking the rotational alignment operation of the goods with the input operation of the goods, it is possible to smoothly and appropriately perform the input operation of the goods according to the state of alignment of the goods in the rotary alignment apparatus, etc., and to optimize the input operation of the goods from the input device to the rotary alignment apparatus.

The goods alignment supply method (3) of the present invention is characterized in that, in the above-mentioned the goods alignment supply method (1) or (2), the controller controls transfer operation of the goods by the transfer robot and conveyance operation of the goods by the conveyor in an integrated manner.

According to the goods alignment supply method (3), by integrating control by linking the transfer operation of the goods with the conveyance operation of the goods, it is possible to smoothly and appropriately perform the conveyance operation of the goods according to the state of transfer of the goods by the transfer robot, etc., and to optimize the conveyance operation of the goods by the conveyor.

The goods alignment supply method (4) of the present invention is characterized in that, in any one of the above-mentioned the goods alignment supply method (1)˜(3),
the rotary alignment apparatus comprises:
a outer rotator having outer ring on which the goods can be placed side by side in the direction of rotation;
a inner rotator having inner disk arranged in an inclined posture inside the outer rotator;
the visual sensor having imaging unit for capturing images of a portion area of the outer ring;
the transfer robot having a holder for holding the goods located within a predetermined area of the outer ring;
the controller implement the first control that tracks the goods captured by the imaging unit and changes the rotation speed of the outer ring based on the tracking information of the goods in the outer ring, and the second control that tracks the goods at the outer ring in response to the first control, and controls the operation of holding the goods located within the predetermined area of the outer ring by the holder.

According to the goods alignment supply method (4), the first control and the second control are executed by the controller. So there are no delays in these controls. Based on the tracking information of the goods in the outer ring, the rotation speed of the outer ring can be changed to track the goods in the outer ring while smoothly executing the operation of holding the goods located in the predetermined area of the outer ring by the holder.

Therefore, even if the state of alignment of the goods in the outer ring is uneven, the operational efficiency of transferring the goods from the rotary alignment apparatus to the conveyor can be improved, and the supply capacity of the goods from the rotary alignment apparatus to the conveyor can be reliably improved.

The goods alignment supply method (5) of the present invention is characterized in that, in the above-mentioned the goods alignment supply method (4), wherein the predetermined area of the outer ring is divided into multiple areas in the direction of rotation, and the controller, in the first control, determines in which of the multiple areas the tracked goods is located, and controls the switching of the rotation speed of the outer ring according to the determination.

According to the goods alignment supply method (5), the controller, in the first control, determines in which of the multiple areas the tracked goods is located, and controls the switching of the rotation speed of the outer ring according to the determination. So the rotation speed of the outer ring can be switched according to the position of the goods in the predetermined area of the outer ring, in the second control, it is possible to equalize or shorten the operating intervals for transferring the goods located within the predetermined area of the outer ring to the conveyor.

The goods alignment supply method (6) of the present invention is characterized in that, in the above-mentioned the goods alignment supply method (5), wherein the controller, in the first control, switches the rotation speed of the outer ring so that, of the multiple areas, the area upstream of the rotation direction has a higher rotation speed than the area downstream of the rotation direction.

According to the goods alignment supply method (6), the controller, in the first control, switches the rotation speed of the outer ring so that, of the multiple areas, the area upstream of the rotation direction has a higher rotation speed than the area downstream of the rotation direction.

In other words, the controller, in the first control, switches the rotational speed of the outer ring so that, of the multiple areas, the area downstream of the rotation direction has a slower rotation speed than the area upstream of the rotation direction.

Therefore, when the tracked goods is located in the upstream area of the rotation direction, the distance between the goods and the holder can be accelerated by setting the rotation speed to a relatively higher value than when the goods is located in the downstream area. Therefore, it is possible to shorten the operating interval for transferring the goods to the conveyor, thereby improving the supply capacity per unit of time.

When the tracked goods is located in the downstream area of the rotation direction, the rotation speed is set to a relatively slower value than when the goods is located in the upstream region, thereby delaying the separation of the distance between the goods and the holder. The spread of operating intervals for transferring the goods to the conveyor can be reduced.

It is possible to securely hold the goods within a predetermined area of the outer ring to prevent transfer leakage (overflow) of the goods, thereby improving the supply capacity per unit of time.

### BRIEF DESCRIPTION OF DRAWINGS

FIG. 1 is a block diagram showing an essential part of a goods alignment supply equipment according to an embodiment of the present invention;

FIG. 2 is a block diagram showing the hardware configuration of a controller of the goods alignment supply equipment;

FIG. 3 is a block diagram showing the functional configuration of the control unit of the goods alignment supply equipment;

FIG. 4 illustrates an example of a processing operation performed by a rotation speed control part of the controller, and is a schematic plan view of a portion of the article alignment supply equipment;

FIG. 5 is a partial cross-sectional front view of a main part of the article alignment supply equipment;

FIG. 6 is a partial cross-sectional side view of the main part of the article alignment supply equipment;

FIG. 7 is a plan view of the main part of the article alignment supply equipment;

FIGS. 8A and 8B show examples of a holder on a transfer robot; FIG. 8(a) is a front view and FIG. 8(b) is a side view;

FIGS. 9A-9C show an example of the movement of the goods held in the holder of a transfer robot;

FIG. 10 is a flowchart showing the processing operations performed by a visual sensor of the goods alignment supply equipment;

FIG. 11 is a flowchart showing the processing operations for the rotary alignment apparatus performed by the controller of the goods alignment supply equipment;

FIG. 12 is a flowchart showing the processing operations for the rotary alignment apparatus performed by the controller of the goods alignment supply equipment;

FIG. 13 is a flowchart showing the processing operations for a transfer robot performed by the controller of the goods alignment supply equipment;

FIG. 14 is a plan view of the main part of a conventional goods alignment supply equipment;

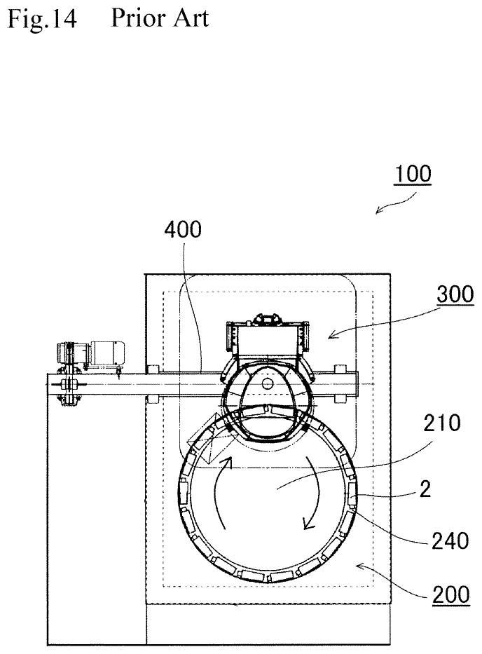

### DESCRIPTION OF EMBODIMENTS

The preferred embodiments of the goods alignment supply equipment and the goods alignment supply method according to the present invention are described below by reference to the Figures.

The following embodiments of the invention are suitable specific examples of the invention and are subject to various technically preferred limitations, but the scope of the invention is not limited to these embodiments unless specifically stated to limit the invention in the following description.

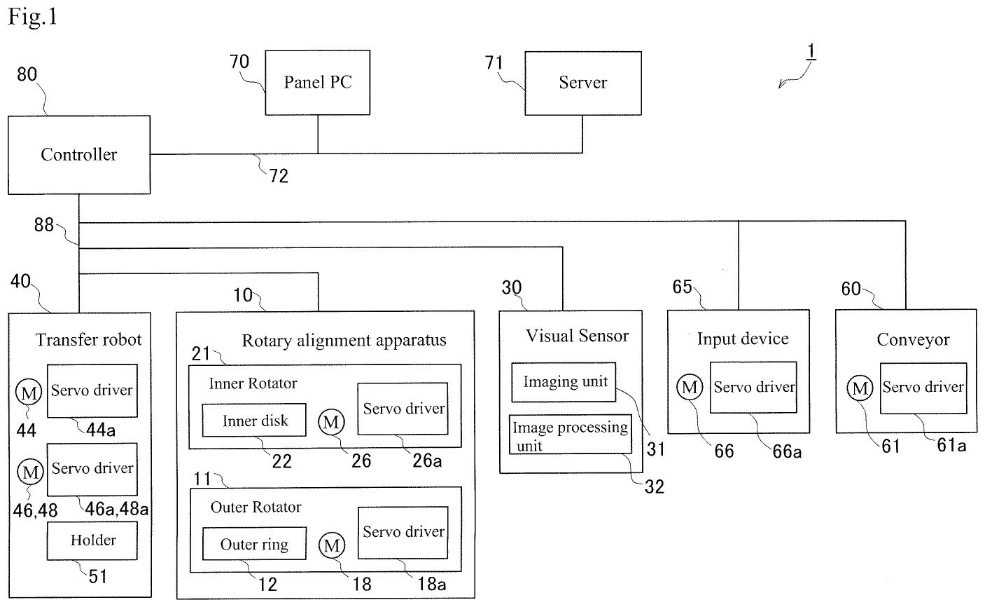

FIG. 1 is a block diagram showing an essential part of a goods alignment supply equipment according to an embodiment of the present invention.

The goods alignment supply equipment 1 is an apparatus that feeds goods supplied in pieces to the rotary alignment apparatus 10 to a conveyor 60 in a predetermined posture.

Target goods are, for example, containers filled with contents such as liquids, powders, and granular materials. The container has, for example, a head with a mouth into which contents are inserted and removed, a bottom with a larger area than the mouth, and a body between the head and the bottom.

The body may be circular, oval, square, or other shape in its cross section, or may have curved sides from the bottom to the head. The predetermined posture is, for example, an upright posture with the bottom of the container down.

The goods alignment supply equipment 1 has the rotary alignment apparatus 10, a visual sensor 30, a transfer robot 40, an input device 65, and the conveyor 60, each of which is connected to a controller 80 via a network cable 88. The controller 80 is also connected to a panel PC 70 and a server 71 via a network 72.

The rotary alignment apparatus 10 has an outer rotator 11 with an annulus outer ring 12 on which the goods 2 can be placed side by side in a predetermined rotational direction, and an inner rotator 21 with an inner disk 22 that is arranged in an inclined posture inside the outer rotator 11.

The outer rotator 11 is equipped with a servomotor 18 and a servo driver 18a as a drive source to rotate the outer rotator 11 including the outer ring 12. The inner rotator 21 is equipped with a servomotor 26 and a servo driver 26a as a drive source to rotate the inner disk 22. The rotational movements of these outer rotator 11 and the inner rotator 21 are then controlled by the controller 80.

The visual sensor 30 is a sensor for recognizing the goods 2 in alignment at the rotary alignment apparatus 10. The visual sensor 30 is equipped with a imaging unit 31 located in a position that enables imaging of a part of outer ring 12 area, and an image processing unit 32 that performs the process of recognizing the goods from the image captured by the imaging unit 31, and the recognition data of the goods recognized by the visual sensor 30 is sent to the controller 80.

The recognition data of the object includes, for example, coordinate information of the object recognized in the captured image area, which coordinate information includes, for example, coordinates indicating characteristic points such as the center and contour of the object on the image, and information on posture such as orientation (angle).

The transfer robot 40 is a picking robot for transferring said articles present on the outer ring 12 recognized by the visual sensor 30 to the conveyor 60. The transfer robot 40 can employ general-purpose robots, such as parallel link robots, horizontally articulated robots (also called SCARA robots), or vertically articulated robots, for example.

Among these general-purpose robots, it is preferable to use parallel link robots, which are capable of high-speed, precise movements and have excellent tracking performance. The following description assumes that a parallel link robot is employed as the transfer robot 40.

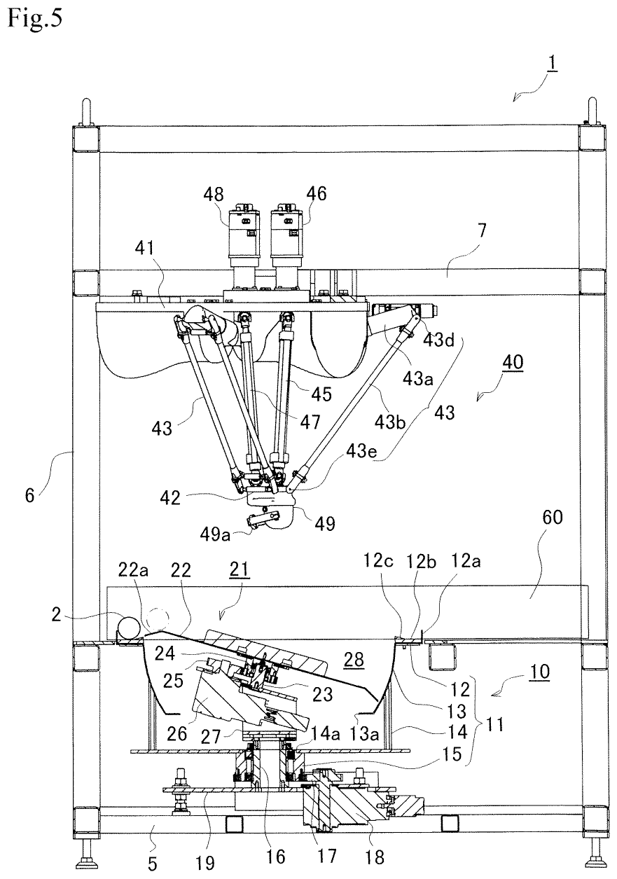

The transfer robot 40 has a servomotor 44 and a servo driver 44a as a drive source to drive each of a plurality of link 43 in parallel between a base 41 and an end 42, which constitute a parallel link robot, as shown in FIGS. 1 and 5.

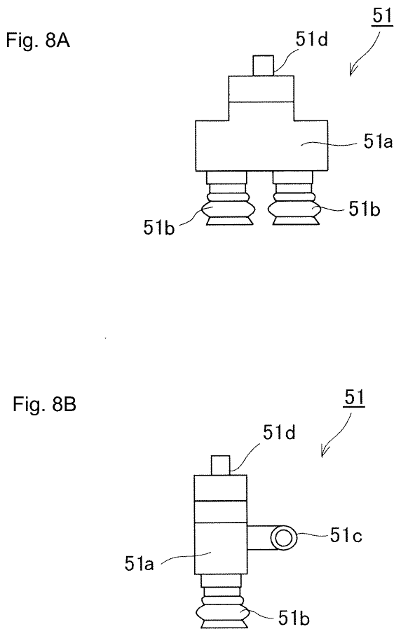

The transfer robot 40 also has a holder 51 (FIG. 8), which is attached to the end 42 and holds an object, and the servomotor 46, the servomotor 48 and a servo driver 46a, a servo driver 48a as a drive source to drive the 1st shaft 45, a 2nd shaft 47 for rotating the holder 51 horizontally and vertically.

The movement of the end 42 by each the link 43 and the rotation of the holder 51 by each the 1st shaft 45 and the 2nd shaft 47 are controlled by the controller 80.

The input device 65 is a device for loading said goods into the rotary alignment apparatus 10, for example, conveying said goods from a hopper, not shown, to the rotary alignment apparatus 10 via a lift conveyor or chute, and refilling said goods into the rotary alignment apparatus 10.

The input device 65 is equipped with a servomotor 66 and a servo driver 66a as a drive source to drive the lift conveyor, and their operation is controlled by the controller 80.

For example, the controller 80 controls driving the lift conveyor or adjusting its drive speed in response to the rotational motion or rotational speed of the outer rotator 11 or the inner rotator 21 of the rotary alignment apparatus 10.

Alternatively, the controller 80 controls driving the lift conveyor or adjusting its drive speed, etc., so that said goods can be fed into the rotary alignment apparatus 10 according to the amount of said goods fed from the rotary alignment apparatus 10 to the conveyor 60 by the transfer robot 40.

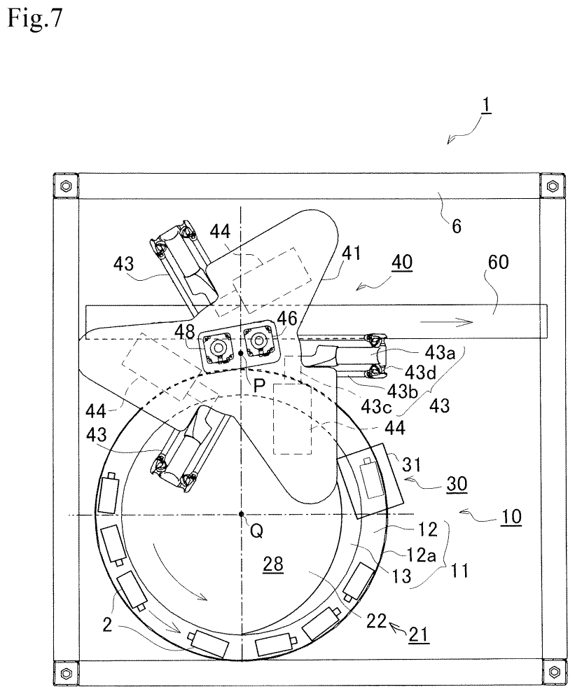

The conveyor 60 is a device with a conveyor part 62 (FIG. 7), located in proximity to the rotary alignment apparatus 10 and used to transport said articles transferred by the transfer robot 40 from the rotary alignment apparatus 10 to the next process.

The conveyor 60 is equipped with a servomotor 61 and a servo driver 61a as a drive source to drive the conveyor part 62, and their operation is controlled by the controller 80.

For example, the controller 80 controls adjusting the drive speed of the conveyor part 62 according to the amount of said goods supplied from the rotary alignment apparatus 10 to the conveyor 60 by the transfer robot 40.

The network cable 88 consists, for example, of a bus or network for periodic communication. Such buses or networks can employ EtherCAT (registered trademark), EtherNet/IP (registered trademark), etc. The network cable 88 may be equipped with a branch slave to make branch connections.

The panel PC 70 is equipped with a monitor screen and operation buttons, and also functions as a control panel, enabling setting input of various operating conditions, operation, operation monitoring, and operations to respond to problems, etc.

The monitor screen is a touch panel screen, which allows the user to switch screens and graphically display the control status of the various parts that make up the goods alignment supply equipment 1 according to the user's touch operation.

The server 71 is a computer device for performing functions as a database system or a manufacturing execution system, for example, to monitor and manage the entire production by obtaining information from each of the parts that make up the goods alignment supply equipment 1. A common network protocol such as EtherNet (registered trademark) can be adopted for the network 72.

The controller 80 is a device that controls control objects such as the rotary alignment apparatus 10, the transfer robot 40, the input device 65, and the conveyor 60 in an integrated manner; in other words, it is an integrated controller that integrally implements programs for these control objects.

The controller 80 executes the programs for these control objects on a single platform and has the ability to synchronize and control the operation of the rotary alignment apparatus 10, the input device 65, and the conveyor 60 and the operation of the transfer robot 40.

Specifically, the controller 80 has the function of obtaining the recognition information of said articles from the visual sensor 30 and controlling the rotational alignment operation of said articles by the rotary alignment apparatus 10 and the transfer operation of said articles by the transfer robot 40 in an integrated manner.

In addition, the controller 80 has the function of controlling the rotational alignment operation of said articles by the rotary alignment apparatus 10 and the input operation of said articles by the input device 65 in an integrated manner.

Furthermore, the controller 80 has the function of controlling the transfer operation of said articles by the transfer robot 40 and the conveyance operation of said articles by the conveyor 60 in an integrated manner.

The controller 80 may be further configured to be connected to a safety controller, emergency stop switch, etc., which builds a safety control circuit for the goods alignment supply equipment 1.

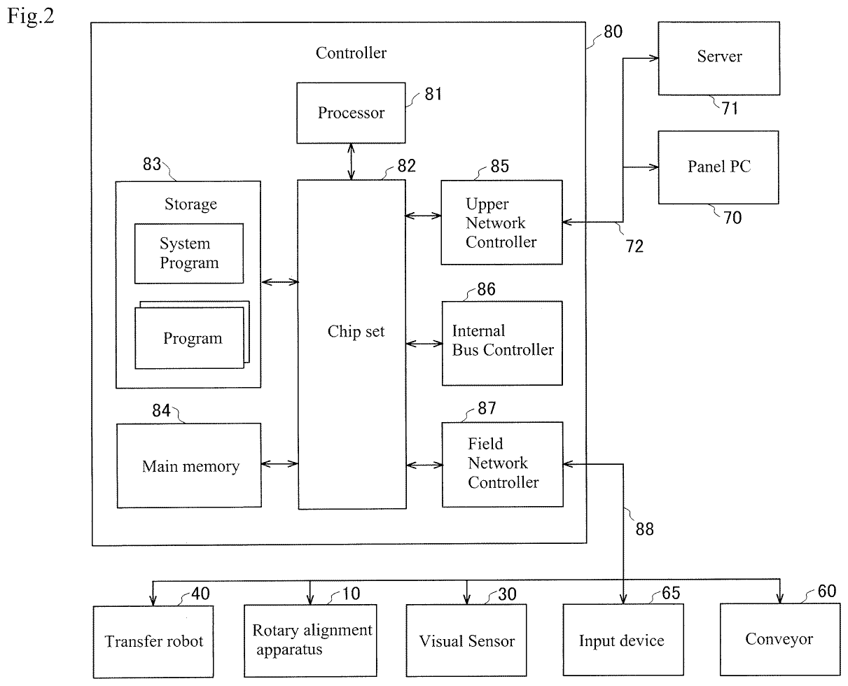

Next, the hardware configuration of the controller 80 in the goods alignment supply equipment 1 is described. FIG. 2 is a block diagram showing an example of the hardware configuration of the controller 80 of a goods alignment supply equipment 1

The controller 80 has the processor 81, a chip set 82, a storage 83, and a main memory 84. The controller 80 is also equipped with a upper network controller 85, a internal bus controller 86, and a field network controller 87, among others.

The processor 81 is an arithmetic processing unit and consists of a CPU (Central Processing Unit), MPU (Micro Processing Unit), or GPU (Graphics Processing Unit). The processor 81 may consist of multiple cores or multiple processors.

That is, the controller 80 has at least one or more processors and/or a processor with at least one or more cores. The processor 81 reads the program stored in the storage 83, expands it to the main memory 84, and executes it to realize the process of comprehensively controlling the control target of the goods alignment supply equipment 1. Specific processing operations are described below.

The chip set 82 consists of the processor 81, the main memory 84, and such as LSI sets that manage data transfer between other peripheral elements. The main memory 84 consists of volatile storage devices such as Dynamic Random Access Memory (DRAM) and Static Random Access Memory (SRAM).

The storage 83 consists of a non-volatile storage device, such as a hard disk drive (HDD) or solid state drive (SSD), for example. The storage 83 contains the system program that allows the controller 80 to perform basic functions. In addition, the storage 83 contains at least one or more programs created for each device to be controlled by the controller 80.

These programs include alignment control programs of the rotary alignment apparatus 10, robot control programs of the transfer robot 40, input control programs of the input device 65, and conveyance control programs of the conveyor 60.

These programming languages are then integrated to enable synchronized execution of sequence control and motion control based on the status of each of the devices of the rotary alignment apparatus 10, the input device 65, and the conveyor 60 and signals such as the visual sensor 30, as well as robot control of the transfer operation of said goods by the transfer robot 40, on a single platform.

The upper network controller 85 has the function of controlling the exchange of data to and from the panel PC 70, the server 71, etc. via the network 72. The internal bus controller 86 has the function of controlling data exchange with various I/O units (not shown) and other units attached to the controller 80. The field network controller 87 has the function of controlling the exchange of data to and from each device connected via the network cable 88.

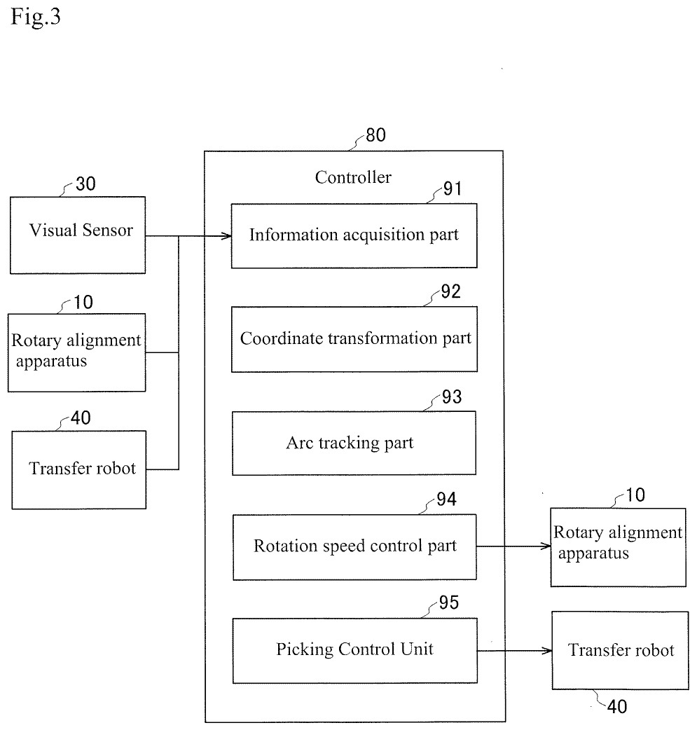

Next, the characteristic functional configuration of the controller 80 of the goods alignment supply equipment I will be described. FIG. 3 is a block diagram showing an example of the characteristic functional configuration of the controller 80 of the goods alignment supply equipment 1.

See FIGS. 1 and 5, etc., for the components of the rotary alignment apparatus 10, the visual sensor 30, and the transfer robot 40. The controller 80 comprises an information acquisition part 91, a coordinate transformation part 92, an arc tracking part 93, a rotation speed control part 94, and a picking control unit 95.

The information acquisition part 91 processes to acquire recognition data of said articles detected by the visual sensor 30, signals from rotary angle detectors (not shown) incorporated in the servomotor 26 of the inner rotator 21 of the rotary alignment apparatus 10 and the servomotor 18 of the outer rotator 11, etc., signals from rotary angle detectors (not shown) incorporated in the servomotor 44, the servomotor 46, the servomotor 48, etc., of the transfer robot 40

The rotary angle detector is, for example, an encoder, and the information acquisition part 91 has processing functions to detect angles for position control of these servomotor 18, servomotor 26, servomotor 44, servomotor 46, and the servomotor 48 and speed for speed control based on signals from the encoder.

The coordinate transformation part 92 has a processing function that converts the coordinate information on the image of the item contained in the recognition data of said item obtained from the visual sensor 30 into the coordinate information on the outer ring 12 of the rotary alignment apparatus 10 or into the robot coordinates used in the control of the transfer robot 40.

The arc tracking part 93 is equipped with a function to perform operations such as tracking (also called following or tracking) the coordinates on the outer ring 12 of said article in accordance with the rotational movement of the outer ring 12, based on the coordinate information on the outer ring 12 of said article converted by the coordinate transformation part 92 and the signals from the servomotor 18 of the rotary alignment apparatus 10 obtained by the information acquisition part 91 (such as the signals from the rotation angle detector).

The rotation speed control part 94 has the function of controlling a change in the rotation speed of the outer ring 12 based on the tracking information of said article at the outer ring 12 (hereinafter referred to as tracking coordinate information), which is calculated by the arc tracking part 93.

In addition, the rotation speed control part 94 has functions such as controlling the rotational speed of the inner disk 22 to synchronize with changes in the rotational speed of the outer ring 12. The first control is executed by the arc tracking part 93 and the rotation speed control part 94.

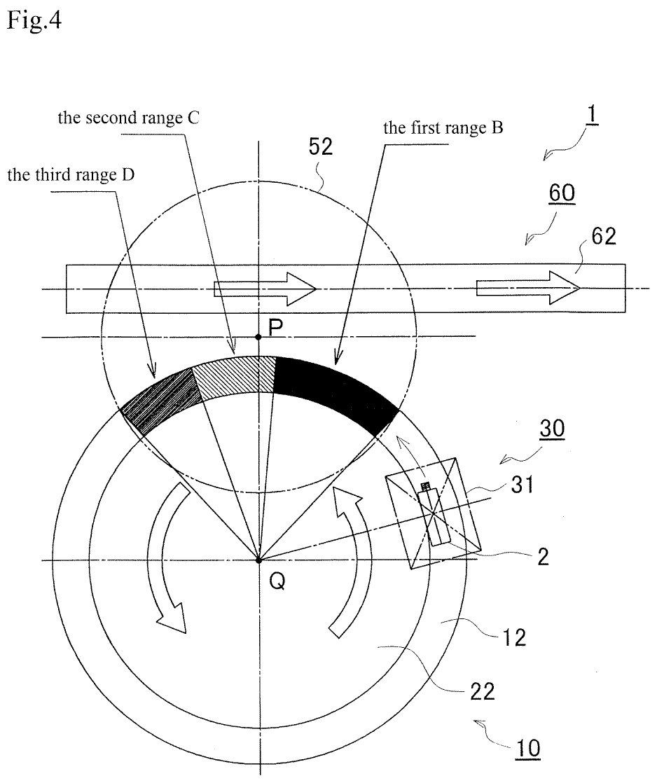

FIG. 4 illustrates an example of a processing operation performed by the rotation speed control part 94 of the controller 80, and is a schematic plan view of a portion of the article alignment supply equipment 1.

In the example shown in FIG. 4, the inner disk 22 and the outer ring 12 of the rotary alignment apparatus 10 are configured to rotate leftward, respectively the conveyor 60 has a line the conveyor part 62 and is located proximate to the outside of the outer ring 12 of the rotary alignment apparatus 10. In the example shown in FIG. 4, the conveyor part 62 is configured to transport 2 to the right.

The transfer robot 40 is then placed above the area where the rotary alignment apparatus 10 and the conveyor 60 are closest to each other. The circle of a predetermined radius with a center point in the area closest to the aforementioned area represents the movable area of the holder 51 (FIG. 8) in the transfer robot 40. The movable area is, in other word, a picking area 52. The center point of the picking area 52 is set at the origin (reference position) P of the holder 51 of the transfer robot 40.

The rotary alignment apparatus 10, the transfer robot 40, and the conveyor 60 are arranged so that the line connecting the origin P of the holder 51 and the centers Q of the inner disk 22 and the outer ring 12 is orthogonally aligned with the conveyor part 62 of the conveyor 60.

In addition, the imaging unit 31 of the visual sensor 30 is located upstream in the direction of rotation of the outer ring 12 from the area where the picking area 52 and the outer ring 12 overlap, at a position where a portion of the area of the outer ring 12 can be imaged.

The imaging unit 31 is composed of a lens, not shown in the figure, and an image sensor as well as illumination, etc. Image data captured by the imaging unit 31 is sent to the image processing unit 32. In addition, the imaging unit 31 has a protective cover to reduce the effects of ambient light.

The visual sensor 30 may be equipped with more than one imaging unit 31. Thus, the transfer robot 40 is positioned so that the holder 51 can be located downstream of the outer ring 12 in the direction of rotation than the imaging unit 31 and on the area where 10 and the conveyor 60 are closest to each other.

In order to perform the characteristic process by the rotation speed control part 94 of the controller 80, the area where the picking area 52 and the outer ring 12 overlap, i.e., the area on the outer ring 12 within the picking area 52, is divided into multiple areas.

In the example shown in FIG. 4, the area on the outer ring 12 in the picking area 52 is set up in three regions, first range B, second range C, and third range D, starting from upstream in the direction of rotation of the outer ring 12.

That is, the first range B is the area upstream in said rotational direction from the origin P of the holder 51, the second range C is the area downstream in said rotational direction from the first range B and from the origin P of the holder 51, and the third range D is the area downstream in said rotational direction from the second range C.

The rotation speed control part 94 is equipped with a function that judges which of the multiple regions (the first range B, the second range C, and the third range D) the goods 2 tracked by the arc tracking part 93 is located in, and controls (1st control) the rotation speed of the outer ring 12 according to the judgment.

In executing the above decision, it is preferable to determine whether the goods 2 are located in order from the region downstream of rotational directions of the outer ring 12 in order to minimize the number of the goods 2 missed by the transfer robot 40.

For example, in the example shown in FIG. 4, first, it determines whether or not the goods 2 is located in range 3D. If the goods 2 is not located in the third range D, the next step is to determine if the goods 2 is located in the second range C. If the goods 2 is not located in the second range C, the next step is to determine if the goods 2 is located in the first range B.

In the control to switch the rotation speed of the outer ring 12 according to the above judgment, the rotation speed of the outer ring 12 is switched so that, of the plurality of areas, the rotation speed of the outer ring 12 is faster when the goods 2 is located in the area upstream of the rotation direction of the outer ring 12 than when the goods 2 is located in the area downstream of the rotation direction.

The switching control involves, for example, the process of outputting a control signal to the servo driver 18a of the outer rotator 11 to switch the rotational speed of the outer ring 12 by the servomotor 18.

For example, in the example shown in FIG. 4, when the goods 2 is located in the third range D, the control switches the rotation speed of the outer ring 12 to speed D.

If there is no goods 2 in the third range D and the goods 2 is located in the second range C, control is performed to switch to speed C. When there is no goods 2 in the third range D or the second range C, and the goods 2 is located in the first range B, the control switches to speed B.

If the goods 2 is not located in the first range B either, the control is switched to speed A. In this case, the rotation speed is set to increase in the order of speed D, speed C, speed B, and speed A. This setting ensures that the throughput (throughput per unit time) of the picking operation of the goods 2 by the transfer robot 40 can be improved.

In other words, when the goods 2 is located in the first range B or upstream of the first range B in the direction of said rotation, it is possible to accelerate the movement of the goods 2 on the outer ring 12 by making the rotation speed of the outer ring 12 relatively faster, so that the picking operation can be performed in an area as close to the origin P of the holder 51 as possible.

On the other hand, if the goods 2 is located in the second range C or the third range D, the rotation speed of the outer ring 12 can be relatively slowed down so that the movement of the goods 2 on the outer ring 12 can be slowed down and the picking operation can be performed in an area as near from the origin P of the holder 51 as possible. When the article is located in the third range D, the rotational speed of the outer ring 12 may be temporarily set to zero.

The picking control unit 95 is equipped with a function to control (2nd control) the picking operation to hold the goods 2 in the area on the outer ring 12 within the picking area 52 and transfer it to the conveyor 60 based on the tracking coordinate information calculated by the arc tracking part 93. In other words, the second control is executed by the arc tracking part 93 and the picking control unit 95.

The transfer robot 40 executes a picking operation to hold and transfer the goods 2 to the conveyor 60, while having the holder 51 follow the goods 2 that exists on the outer ring 12, based on the control signal from the picking control unit 95.

In the example shown in FIG. 4, the direction of movement of the conveyor part 62 of the conveyor 60 is opposite to the direction of rotation of the outer ring 12 of the rotary alignment apparatus 10, but in other forms, they may be the same direction.

Next, we will explain an example of the specific configuration of the goods alignment supply equipment 1. FIG. 5 is a partial cross-sectional front view showing the configuration of the main parts of the goods alignment supply equipment 1.

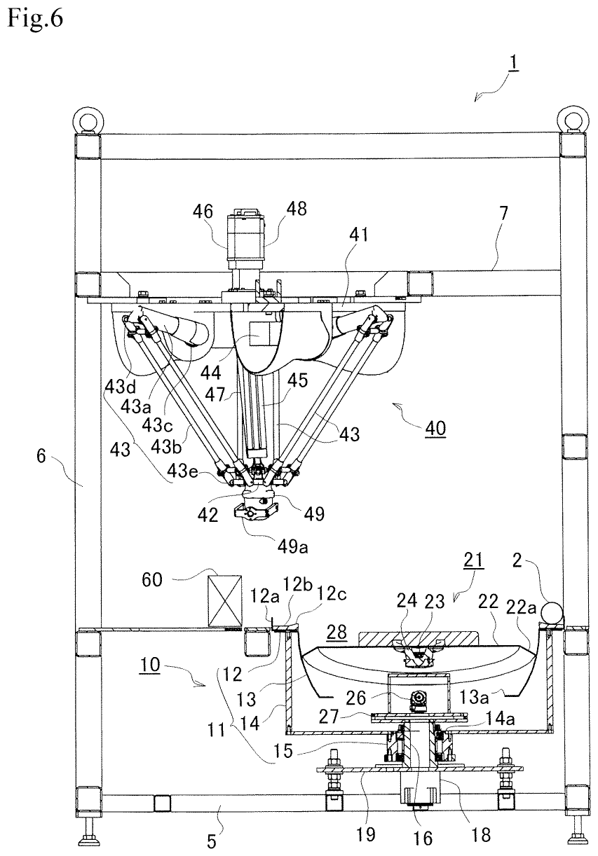

FIG. 6 is a partial cross-sectional side view showing the configuration of the main parts of the goods alignment supply equipment 1. FIG. 7 is a plan view showing the configuration of the main parts of the goods alignment supply equipment 1. FIG. 8 is an example of the holder 51 provided in the transfer robot 40.

The main part of the goods alignment supply equipment 1 is made up of the rotary alignment apparatus 10, the visual sensor 30 and the transfer robot 40, and is also equipped with the conveyor 60.

First, let's explain the structure of the rotary alignment apparatus 10. the rotary alignment apparatus 10 is composed of the outer rotator 11 and the inner rotator 21. The outer rotator 11 is composed of the outer ring 12, a bowl sidewall 13, a bowl support 14, a rotary support 15, the cylinder 16, a gear 17, and the servo motor 18. The bowl sidewall 13 has a bowl shape with a larger upper diameter than a lower diameter, and has a circular opening 13a at the bottom.

The outer ring 12 is provided by extending outward from the upper end of the bowl sidewall 13, and has a circular shape in plan view that allows the goods 2 to be placed in a rotational direction, and has a fall barrier 12a formed on its outer circumference to prevent the goods 2 from falling.

In addition, a goods loading area 12b, which is a circular ring, is arranged on the outer ring 12 surfaces for placing the goods, and an inclined part 12c, which is lower on the outside than on the inside, is provided. The width of the outer ring 12 is slightly larger than the width of the body of the goods 2, in other words, it is wide enough to arrange the goods 2 in a single line.

The bowl support 14 is a component that supports the outer ring 12 and the bowl sidewall 13, and has a shape that surrounds the bowl sidewall 13, with its upper end fixed to the outer surface of the bowl sidewall 13.

In the center of the bottom of the bowl support 14, a circular opening 14a is formed, and the top of the rotary support 15 is fixed to the cylinder 16 is arranged inside the rotary support 15, the rotary support 15 is attached to the cylinder 16 in a rotatable manner.

The lower end of the cylinder 16 is fixed to a first base 19, and the first base 19 is fixed to a low frame 5. The rotary support 15 is supported by the cylinder 16 fixed at the first base 19 in a state where it can rotate around a vertical axis.

The servomotor 18 is attached to the first base 19, and the gear 17 attached to rotation shaft of the servomotor 18 is meshed with the gear (not shown) attached to the bottom of the rotary support 15.

Therefor the rotation of the servomotor 18 is transmitted through the gear 17, the rotary support 15, and the bowl support 14 to the bowl sidewall 13 and the outer ring 12, making it possible to rotate the outer rotator 11.

The inner rotator 21 is composed of the inner disk 22, a shaft part 23, a rotary support 24, a gear 25, and the servomotor 26. The inner disk 22 is arranged in a slanted posture inside the bowl sidewall 13 of the outer rotator 11.

The shaft part 23, which is slanted in relation to the horizontal plane, is attached to the center of the underside of the inner disk 22, and the bottom of the shaft part 23 is attached to the upper sloping surface of a second base 27.

The rotary support 24 is attached to the shaft part 23 in a rotatable state, and the top of the rotary support 24 is fixed to on the underside of the inner disk 22.

The bottom of the second base 27 is fixed to the top of a cylinder 16, and the servomotor 26 is attached to the second base 27, and the gear 25 attached to rotating shafts of the servomotor 26 mesh with the gear (not shown in the diagram) at the bottom of the rotary support 24.

Therefor the rotation of the servomotor 26 is transmitted through the gear 25 and the rotary support 24 to the inner disk 22, allowing the inner rotator 21 to be rotated. In this way, the inner rotator 21 and the outer rotator 11 are configured to rotate using separate driving sources.

The inner disk 22 is rotatable around the shaft part 23, which is inclined with respect to the horizontal plane, and its outer circumference is arranged so that it is close to the bowl sidewall 13.

The angle of inclination of the inner disk 22 relative to the horizontal plane designed to be around 10° to 20°, and can be changed as necessary depending on the size, weight, shape, etc. of the goods 2.

The shape of the inner disk 22 is designed so that the highest point on the outer circumference is at approximately the same height as the outer ring 12.

In addition, the gap formed between the outer circumference of the inner disk 22 and the bowl sidewall 13 should be designed to be as narrow as possible so that the goods 2 does not fall through the gap.

The outer circumference of the inner disk 22 has a slide out 22a that slopes downward toward the outside, and the height of the tip of the slide out 22a and the inner edge of the goods loading area 12b is configured so that they are at approximately the same level at the highest point of the inner disk 22, i.e., a flat sloping state with no steps.

Thanks to this configuration, the goods 2 can be moved from the inner disk 22 to the outer ring 12 smoothly and reliably, and it is possible to make it line up in an orderly fashion.

In the case of the goods 2 with a round cross-section, such as a bottle, it is preferable that the goods loading area 12b, which is arranged in the outer ring 12, is provided with the inclined part 12c. However, in the case of the goods 2 with a square or flat cross-section, such as a bottle, it is preferable that the goods loading area 12b has a horizontal shape.

In addition, it is preferable that the goods loading area 12b be a color that makes it easy to distinguish from the goods 2, and it is constructed so that it can be exchanged depending on the color of the goods 2.

Next, we will explain the alignment operation of the goods 2 using the rotary alignment apparatus 10.

When the goods 2 is fed into a accommodation 28 formed by the bowl sidewall 13 of the outer rotator 11, and the inner disk 22 of the inner rotator 21, the goods 2 in the accommodation 28 rotates and moves within the accommodation 28 in accordance with the rotation of the inner disk 22 and the bowl sidewall 13.

As the goods 2 rotates in the circumference within the accommodation 28, the centrifugal force acts on the goods 2, causing it to move from the center to the outside.

When the goods 2 moves outward and reaches a height of the outer ring 12 on the inner disk 22, the goods 2 moves to the outer ring 12 by being pushed out from the inner disk 22.

Because the fall barrier 12a is provided on the outer circumference of the outer ring 12, the goods 2 is placed with its length direction along the fall barrier 12a.

After that, the goods 2 rotates and moves as the outer rotator 11 rotates, while remaining on the goods loading area 12b. If the goods 2 is not removed from the outer ring 12, the goods 2 will continue to rotate.

When the goods 2 is removed from the outer ring 12 and a space is created for the goods 2 to enter the outer ring 12, the goods 2 in the accommodation 28 is placed in the empty space on the outer ring 12 as a result of the rotation of the inner disk 22, etc.

Also, if the empty space above the outer ring 12 is narrow and the highest point is on the outer circumference of the inner disk 22, and if the goods 2 is placed at an angle to the outer ring 12, then as the outer rotator 11 and the inner disk 22 rotate, the inner disk 22 will become lower in height relative to the outer ring 12, and the goods 2 will no longer be supported on the side of the inner disk 22.

Therefore, the goods 2 that did not ride in the state of being aligned in the outer ring 12 falls into the accommodation 28 and rotates and moves within the accommodation 28 again.

Therefore, only the goods 2, which is lined up along the fall barrier 12a, will rotate and move in a circular direction on the outer ring 12.

Furthermore, although the orientation of the items 2 lined up in the outer ring 12, for example the orientation of the head relative to the bottom, is not the same, as described later, it is possible to move the goods 2 to the same posture and transfer it to the conveyor 60 by using the transfer robot 40.

The rotary alignment apparatus 10 is capable of aligning and placing the goods 2 in the circular ring the outer ring 12, with the head and bottom of the goods 2 facing in the circumferential direction, by the action of the outer rotator 11 and the inner disk 22.

The direction of rotation for the outer rotator 11 and the inner disk 22 should be the same so that the movement of the goods 2 from the inner disk 22 to the outer ring 12 proceeds smoothly, and it is preferable to synchronize the rotation operation as well.

Next, we will explain the structure of the transfer robot 40. The transfer robot 40 is a device for placing the goods 2, which rotates on the outer ring 12, on the conveyor part 62 of the conveyor 60 in a specified posture, for example, with the head of the goods 2 facing up and the bottom facing down.

The transfer robot 40 is fixed to a upper frame 7, which is located above a side frame 6, as shown in FIGS. 5 and 6.

In addition, as shown in FIG. 7, the transfer robot 40 is arranged so that the holder 51 can be positioned above the area where the rotary alignment apparatus 10 and the conveyor 60 are closest together, which is downstream of the imaging unit 31 by the outer ring 12 rotations.

As a result, it is possible to minimize the distance that the goods 2 travels from the time it is held in the holding section the holder 51 to the time it is placed on the conveyor 60, and it is possible to reduce the time required to transfer the goods 2.

The transfer robot 40 is composed of a parallel link robot with three links 43 arranged in parallel between the upper base 41 and the lower end 42, and the holder 51 shown in FIG. 8 can be attached to a end effector 49 attached to the end 42.

In addition, the transfer robot 40 has the 1st shaft 45 and a 2nd shaft 47 between the base 41 and the end 42.

Each link 43 has an upper arm 43a and a parallel arm 43b, and a rotary joint 43c is located between the base 41 and the upper arm 43a, a spherical joint 43d is located between the upper arm 43a and the parallel arm 43b, and a spherical joint 43e is located between the parallel arm 43b and the end 42.

A servo motor 44 for driving the rotation of the rotary joint 43c is attached to the base 41. The end 42 is able to move in three-dimensional space, i.e. forwards, backwards, left and right, and up and down, while maintaining a constant posture, thanks to the operation of these three links 43.

1st shaft 45 and the 2nd shaft 47 are each composed of a rotating telescopic shaft with a universal joint at each end. A servomotor 46 for rotating and extending the 1st shaft 45 is attached to the base 41, and the end effector 49 can be rotated in the horizontal direction by operating the first shaft the 1st shaft 45.

In addition, the servomotor 48 for rotating and extending the 2nd shaft 47 is attached to the base 41, and a rotary support 49a provided on the end effector 49 can be rotated in the vertical direction by the movement of the 2nd shaft 47.

The rotary support 49a has a concave shape, and a mounting section is provided at its lower end for attaching the holder 51.

The end effector 49 attached to the end 42 is capable of three-dimensional movement in the front-back, left-right, and up-down directions thanks to the operation of these three links 43, and is also capable of horizontal rotation via the 1st shaft 45, and vertical rotation of the rotary support 49a via the 2nd shaft 47.

FIG. 8 shows an example of the holder 51 provided on the transfer robot 40, (a) is a front view and (b) is a side view.

The holder 51 is an adsorption-type holding means, and is composed of a suction box 51a, two adsorption pad 51b on the underside of the suction box 51a, a connector 51c for connecting a hose for vacuum suction and exhaust to the side of the suction box 51a, and a attachment part 51d for mounting to the rotary support 49a of the end effector 49.

The adsorption pad 51b is a bellows-type pad with at least one stage, so that it can quickly and reliably hold or release the goods 2, and its material is, for example, nitrile rubber, silicone rubber, or natural rubber.

In addition, the adsorption pad 51b is detachable from the suction pad insertion hole provided on the underside of the suction box 51a, and can be replaced as necessary according to the size, shape, etc. of the goods 2.

In the example in FIG. 7, the holder 51 has two adsorption pads 51b, but it is also possible to have just one or more than three adsorption pads 51b.

In addition, FIG. 8 shows an example in which the holder 51 is of the adsorption type, but the holder 51 is not limited to the adsorption type, and depending on the goods 2, it may be of the gripping type that holds it by clamping it. The type of the holder 51 can be selected as appropriate according to the goods 2.

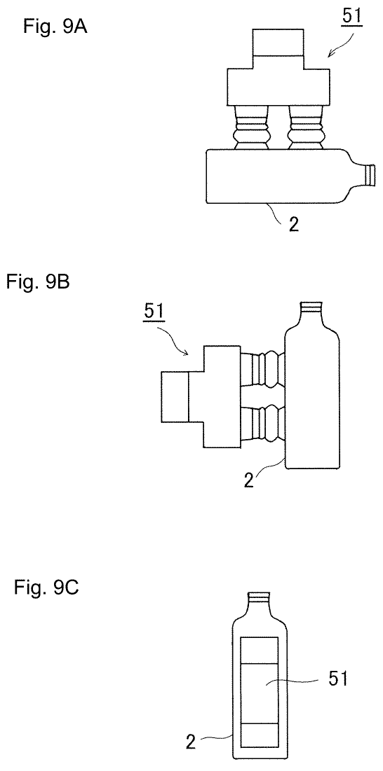

FIG. 9 shows an example of the movement of a goods held in the holder 51.

FIG. 9(a) shows the state in which the goods 2, which is lying in an aligned state on the outer ring the outer ring 12 of the rotary alignment apparatus 10, is held by the absorption pad 51b of the holder 51.

If the rotary support 49a of the end effector 49 is rotated 90° in the vertical direction from the state shown in FIG. 9(a), the adsorption pad 51b of the holder 51 will also rotate 90° in the vertical direction, as shown in FIG. 9(b), and the goods 2 will be in a state with its head facing up and its bottom facing down.

The direction in which the rotary support 49a is rotated 90° in the vertical direction is controlled so that the head of the goods 2 is facing upwards and the bottom is facing downwards, in accordance with the orientation of the head of the goods 2 lying aligned with the outer ring the outer ring 12.

If the end effector 49 is rotated 90° in the horizontal direction from the state shown in FIG. 9(b), the adsorption pad 51b of the holder 51 also rotates 90° in the horizontal direction while keeping the goods 2 in an upright posture, resulting in the state shown in FIG. 9(c).

After that, the transfer robot 40 moves the holder 51, which is holding the goods 2, onto the conveyor 60 by operating the link 43, and then the goods 2 is released from the adsorption pad 51b of the holder 51, and the goods 2 is placed on the conveyor part 62 in an upright posture.

It is preferable to operate the end effector 49 and the holder 51 so that the movements of the goods 2 shown in FIG. 9(a), (b), and (c) progress at approximately the same time.

Also, the movement of the link 43 causes the movement of the end 42 in the front-back, left-right, and up-down directions is executed in parallel with the movement of the goods 2 by the end effector 49 shown in FIG. 9.

As a result, the movement from holding the goods 2 in the rotary alignment apparatus 10 by the holder 51 to moving the goods 2 to the nearby conveyor 60 in an upright posture can be executed in an extremely short time.

Next, we will explain an example of the goods alignment and supply processing operation performed by the controller 80 of the goods alignment supply equipment 1.

For details of the individual components of the goods alignment supply equipment 1, please refer to FIGS. 1 to 9. The controller 80 performs comprehensive control of the visual sensor 30, the rotary alignment apparatus 10, and the transfer robot 40.

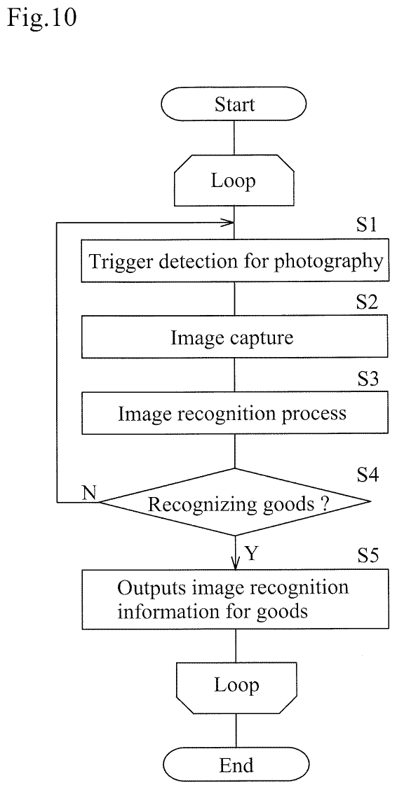

FIG. 10 is a flowchart showing an example of the processing operations performed by the visual sensor 30. This loop process is used to recognize the goods 2 that is moving on the outer ring 12, and is repeated while the visual sensor 30 is turned on.

First, in step S1, the visual sensor 30 detects the trigger signal indicating the imaging timing and proceeds to step S2.

In step S2, the visual sensor 30 takes an image of a part of the outer ring 12 using the imaging unit 31, and then proceeds to step S3.

The trigger signal may be a timer signal indicating a predetermined time interval set in accordance with the rotational speed of the outer ring 12, or it may be a detection signal output from a sensor such as a photoelectric sensor that detects the passage of the goods 2 on the outer ring 12, which is arranged downstream of the rotational direction of the imaging unit 31. The timer signal may be obtained from the controller 80.

In step S3, the visual sensor 30 performs image recognition processing on the image captured in step S2 in the image processing unit 32, and proceeds to step S4.

In the image recognition process, for example, the process of extracting feature points (coordinates on the image) such as the outline and center point of the goods 2 from the captured image is performed, and the process of extracting the presence or absence of the goods 2 by pattern matching, etc., and the feature points (coordinates on the image) and orientation (angle on the image) of the goods 2 is performed.

In step S4, the visual sensor 30 determines whether or not the goods 2 have been recognized in the captured image as a result of the image processing by the image processing unit 32, and if it is determined that the goods 2 have not been recognized, it returns to step S1 and repeats the process.

On the other hand, if it is judged that the goods 2 have been recognized in step S4, proceed to step S5. In step S5, the visual sensor 30 processes the image recognition information of the goods 2 and outputs it to the controller 80.

The image recognition information for the goods 2 includes information such as the image frame information, the timing of the image capture (time), the coordinate information indicating the feature points of the recognized goods 2 (for example, the X and Y coordinates on the image indicating the center point of the goods 2, etc.), and the orientation of the goods 2 (the angle θ relative to the XY axis of the image).

After step S5, if the power is on, the loop process is repeated, and if the power is off, the loop process is terminated. The continuation condition for the above loop processing can be either while the power supply is on as mentioned above, or until a specified amount of time has passed, or until a specified number of the goods 2 have been recognized, etc.

Next, we will explain an example of the processing operations performed by the controller 80 for the rotary alignment apparatus 10 and the transfer robot 40

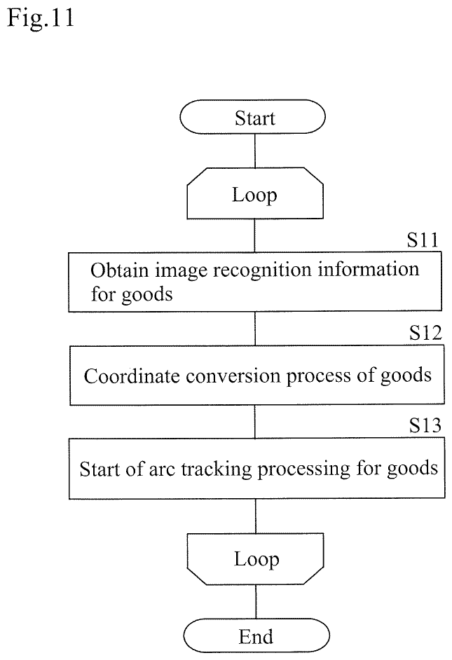

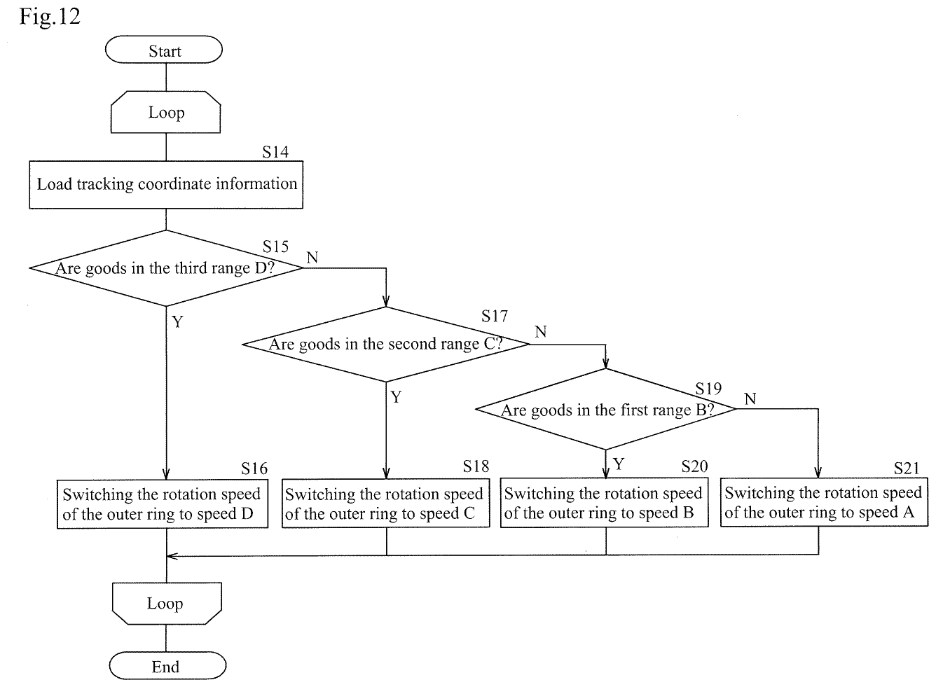

FIGS. 11 and 12 are flowcharts showing an example of the control operations (alignment control program) performed by the controller 80 on the outer rotator 11 of the rotary alignment apparatus 10. In addition, the synchronous control is also performed for the inner rotator 21 of the rotary alignment apparatus 10.

The loop processing shown in FIGS. 11 and 12 is repeated while the power to the servomotor 44 of the outer rotator 11 is ON.

As shown in FIG. 11, the controller 80 starts the loop processing, and first, in step S11, the information acquisition part the information acquisition part 91 of the controller 80 performs the process of acquiring image recognition information of the goods 2 from the visual sensor 30, and proceeds to step S12.

At step S12, the coordinate transformation part 92 of the controller 80 performs a process to convert the coordinate system of the image recognition information of the goods 2 acquired from the visual sensor 30 to the coordinate system of the outer ring 12 and the transfer robot 40.

For example, the coordinate transformation part 92 converts the coordinate information, which includes the position and orientation of the goods 2 in the image, into the coordinate information on the outer ring 12, and then converts it into the robot coordinates of the transfer robot 40, and then proceeds to step S13.

The coordinate information on the outer ring 12 may also be based on the center Q of the outer ring 12. The robot coordinates may also be based on the origin P of the holder 51. The coordinate information on the outer ring 12 of the goods 2 may also be converted to the robot coordinates.

In step S13, the arc tracking part 93 of the controller 80 starts the arc tracking processing of the goods 2.

In the arc tracking process, an arithmetic process is performed to track the movement position (coordinates) of the goods 2 on the outer ring 12 based on the coordinate information on the outer ring 12 of the goods 2 converted in step S12 and the speed information such as the angular velocity of the outer ring 12.

The calculated tracking coordinate information for the goods 2 is sequentially stored in the main memory 84. The speed information for the outer ring 12 is calculated using signals obtained from the encoder of the servomotor 18 that rotates the outer rotator 11, for example.

The relationship between the signal from the encoder and the rotation distance (angle of rotation) of the outer ring 12 is set in advance by calibration or other means.

The above steps S11 to S13 are executed each time new image recognition information for the new goods 2 is obtained, and the tracking coordinate information for each of the captured goods 2 is sequentially stored in the main memory 84.

The controller 80 performs the loop processing shown in FIG. 12 in parallel with the loop processing shown in FIG. 11. The loop processing shown in FIG. 12 is executed at regular intervals, for example.

At step S14 shown in FIG. 12, the rotation speed control part 94 of the controller 80 reads the tracking coordinate information of one or more goods 2 calculated at step S13, and proceeds to step S15.

In step S15, the rotation speed control part 94 determines whether or not the coordinates of the goods 2 are in the third range D (FIG. 4) in the picking area 52 based on the tracking coordinate information of one or more goods 2.

In this embodiment, as shown in FIG. 4, the area of the picking area 52 that overlaps with the outer ring 12 is divided into three judgment areas: the first range B, the second range C, and the third range D, from the upstream side of the rotation direction of the outer ring 12.

The number of divisions of the judgment area is not limited to three, and can be two or more than four, but three divisions are preferable from the perspective of efficiently improving the throughput of the picking operation of the transfer robot 40 without complicating the speed switching processing of the outer ring 12 described later.

If the rotation speed control part 94 judges that the coordinates of the goods 2 are in the third range D of the picking area 52 in step S15, it proceeds to step S16. In step S16, the rotation speed control part 94 performs processing to switch the rotation speed of the outer ring 12 to the specified speed D (<speed C<speed B<speed A).

For example, the rotation speed control part 94 performs the processing of outputting a control signal to switch to the aforementioned speed D to the servo driver 18a of the rotary alignment apparatus 10. After that, if the motor power is ON, the loop processing is repeated, and if the motor power is OFF, the loop processing is terminated.

In the rotary alignment apparatus 10, the rotational speed of the outer ring 12 is controlled by the servo driver 18a so that the rotational speed of the outer ring 12 becomes the speed D based on the control signal that switches to the speed D acquired from the control device 80.

On the other hand, if the rotation speed control part 94 determines in step S15 that the coordinates of the goods 2 are not in the third range D of the picking area 52, it proceeds to step S17.

In step S17, the rotation speed control part 94 determines whether the coordinates of the goods 2 are in the second range C (FIG. 4) of the picking area 52 based on the tracking coordinate information of one or more goods 2 read in step S14.

If the rotation speed control part 94 determines in step S17 that the coordinates of the goods 2 are in the second range C of the picking area 52, it proceeds to step S18. At step S18, the rotation speed control part 94 performs the processing to switch the rotation speed of the outer ring 12 to the predetermined speed C.

For example, the rotation speed control part 94 outputs a control signal to switch to the speed C to the servo driver 18a of the rotary alignment apparatus 10. After that, if the motor power is ON, the loop processing is repeated, and if the motor power is OFF, the loop processing is terminated.

In the rotary alignment apparatus 10, the rotational speed of the outer ring 12 is controlled by the servo driver 18a so that the rotational speed of the outer ring 12 becomes the speed C, based on the control signal that switches to the speed C acquired from the controller 80.

On the other hand, if the rotation speed control part 94 determines in step S17 that the coordinates of the goods 2 are not in the second range C of the picking area 52, it proceeds to step S19.

At step S19, the rotation speed control part 94 determines whether the coordinates of the goods 2 are in the first range B (FIG. 4) of the picking area 52 based on the tracking coordinate information of one or more goods 2 read in at step S14.

If, in step S19, the rotation speed control part 94 determines that the coordinates of the goods 2 are in the first range B of the picking area 52, it proceeds to step S20. At step S20, the rotation speed control part 94 performs the processing to switch the rotation speed of the outer ring 12 to the predetermined speed B.

For example, the rotation speed control part 94 outputs a control signal to switch to the speed B to the servo driver 18a of the rotary alignment apparatus 10. After that, if the motor power is ON, the loop processing is repeated, and if the motor power is OFF, the loop processing is terminated.

In the rotary alignment apparatus 10, the rotational speed of the outer ring 12 is controlled by the servo driver 18a so that the rotational speed of the outer ring 12 becomes the speed B based on the control signal that switches to the speed B acquired from the controller 80.

On the other hand, if the rotation speed control part 94 determines in step S19 that the coordinates of the goods 2 are not in the first range B of the picking area 52, i.e., that the goods 2 are located in the upstream side of the rotation direction of the picking area 52, it proceeds to step S21.

In step S21, the rotation speed control part 94 performs a process to switch the rotational speed of the outer ring 12 to the predetermined speed A. For example, the rotation speed control part 94 outputs a control signal to the servo driver 18a of the rotary alignment apparatus 10 to switch to the speed A. After that, if the motor power is ON, the loop processing is repeated, and if the motor power is OFF, the loop processing is terminated.

In the rotary alignment apparatus 10, the rotational speed of the outer ring 12 is controlled by the servo driver 18a so that the rotational speed of the outer ring 12 becomes the aforementioned speed A based on the control signal that switches to the aforementioned speed A acquired from the controller 80.

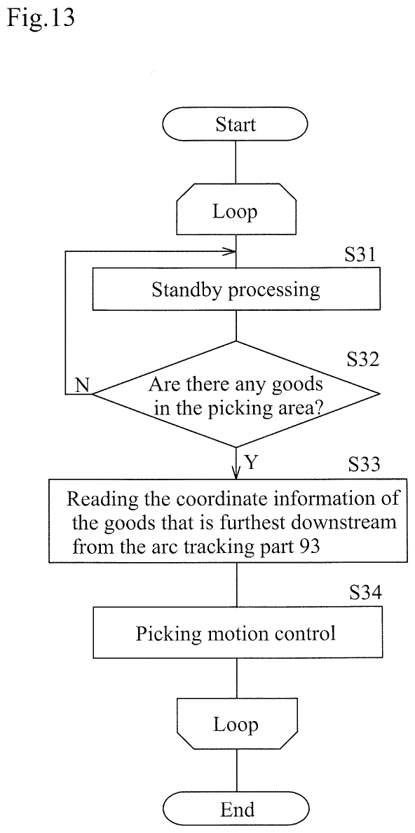

FIG. 13 is a flowchart showing an example of the control operations (robot control program) performed by the controller 80 for the transfer robot 40. The control for the rotary alignment apparatus 10 described above and the control for the transfer robot 40 are performed in parallel.

The loop processing shown in FIG. 13 is repeated while the transfer robot 40 is powered on. The controller 80 starts the loop processing, and at step S31, the picking control unit 95 of the controller 80 performs processing to make the holder 51 of the transfer robot 40 wait at a predetermined position (e.g., the position of the origin P).

For example, the picking control unit 95 processes the standby signal and outputs it to the transfer robot 40, and then proceeds to step S32. In the transfer robot 40, based on the standby signal acquired from the controller 80, the operation of each part such as the link 43 is controlled so that the holder 51 is kept at the predetermined position (origin P).

In step S32, the picking control unit 95 determines whether or not there are any goods 2 in the picking area 52 based on the tracking coordinate information of one or more goods 2.

If the picking control unit 95 determines that there are no goods 2 in the picking area 52 in step S32, it returns to step S31 and continues the standby processing, but if it determines that there are goods 2 in the picking area 52, it proceeds to step S33.

In step S33, the picking control unit 95 reads the tracking coordinate information for the goods 2 that are located furthest downstream in the picking area 52 from the arc tracking part 93, and proceeds to step S34.

At step S34, the picking control unit 95 performs processing to control the picking operation in which the transfer robot 40 transfers the goods 2 from the outer ring 12 to the conveyor 60 based on the tracking coordinate information of the goods 2 that are located at the most downstream.

In the picking operation, the tracking coordinate information (orientation and center coordinates) of the goods 2 at the most downstream location is used to determine the target holding posture of the holder 51, and the processing to determine the direction of rotation of the goods 2 on the vertical plane to make the goods 2 stand up is performed.

Then, while moving the link 43, the 1st shaft 45, and the 2nd shaft 47 so that the holder 51 follows the goods 2 moving on the outer ring 12, the control is performed to hold the goods 2 by the holder 51 at the target holding position, the control is carried out to hold the goods 2 by the holder 51 at the target holding posture and to place the goods 2 in an upright posture on the conveyor part 62 of the conveyor 60 while rotating the goods 2 in the rotational direction determined.

After that, if the power is on, the loop process is repeated, and if the power is off, the loop process is terminated.

According to the above-mentioned embodiment of the goods alignment supply equipment 1, the rotation alignment operation of the goods 2 by the rotary alignment apparatus 10 and the transfer operation of the goods 2 by the transfer robot 40 are controlled in an integrated manner based on the image recognition information of the goods 2 by the controller 80.

Therefore, by integrating the control of the rotation and alignment of the goods 2 and the transfer of the goods 2 on a single platform, it is possible to synchronize the control of these operations and perform smoother control, which in turn increases the efficiency of these operations and improves the supply capacity of the goods 2 from the rotary alignment apparatus 10 to the conveyor 60.

In addition, according to the goods alignment supply equipment 1, the rotation alignment operation of the goods 2 by the rotary alignment apparatus 10 and the input operation of the goods 2 by the input device 65 are controlled in an integrated manner by the controller 80.

Therefore, by integrating the control of the rotation alignment operation and the input operation of the goods 2, it is possible to perform the input operation of the goods 2 smoothly and appropriately according to the alignment state of the goods 2 at the rotary alignment apparatus 10, and it is possible to optimize the input operation of the goods 2 from the input device 65 to the rotary alignment apparatus 10.

In addition, according to the goods alignment supply equipment 1, the transfer operation of the goods 2 by the transfer robot 40 and the conveyance operation of the goods 2 by the conveyor 60 are controlled in an integrated manner by the controller 80.

Therefore, by integrating the control of the transfer operation of goods 2 and the conveyance operation of goods 2, it is possible to smoothly and appropriately perform the conveyance operation of the goods 2 according to the transfer state of the goods 2 by the transfer robot 40, and it is possible to optimize the conveyance operation of the goods 2 by the conveyor 60.

In addition, according to the goods alignment supply equipment 1, rotation speed control (1st control) of the outer ring 12 and picking control (second control) of the goods 2 by the transfer robot 40 are executed by the controller 80. Therefore, it is possible to prevent delays in these controls.

Then, based on the tracking coordinate information of the goods 2 in the outer ring 12, the rotation speed of the outer ring 12 is changed, and while tracking the goods 2 in the outer ring 12, it becomes possible to smoothly execute the operation of holding the goods 2 located in the predetermined area of the outer ring 12 (the first range B, the second range C, the third range D) with the holder 51.

Therefore, even if the alignment of the goods 2 at the outer ring 12 is scattered, the efficiency of the operation to transfer the goods 2 from the rotary alignment apparatus 10 to the conveyor 60 can be improved, and the supply capacity of the goods 2 from the rotary alignment apparatus 10 to the conveyor 60 can be reliably improved.

In addition, according to the goods alignment supply equipment 1, in the rotation control (1st control) performed by the rotation speed control part 94, it judges which of the multiple areas (the first range B, the second range C, the third range D) the tracked goods 2 are located in, and it performs control to switch the rotation speed of the outer ring 12 according to the judgment.

Therefore, rotation speeds of the outer ring 12 can be switched according to the position of the goods 2 within the predetermined areas of the outer ring 12, and in picking control (2nd control), the operation interval for transferring the goods 2 located within the predetermined areas of the outer ring 12 to the conveyor 60 can be equalized or shortened.

In addition, according to the goods alignment supply equipment 1, in the rotation control (1st control) performed by the rotation speed control part 94, of the multiple areas (the first range B, the second range C, the third range D), the area (the first range B) on the upstream side of the rotation direction is made to have a rotation speed of the outer ring 12 faster than the area (the third range D) on the downstream side of the rotation direction (the third range D) is slower than the upstream area (the first range B) by rotations, in other words, the downstream area (the third range D) is slower than the upstream area (the first range B) by rotations.

Therefore, when the tracked goods 2 are located in the upstream area (the first range B) of the above-mentioned rotational direction, the rotational speed can be set to a relatively faster value than when the goods are located in the downstream area (the second range C, the third range D), thereby accelerating the approach of the distance between the goods 2 and the holder 51.

Therefore, it is possible to shorten the time between operations to transfer the goods 2 to the conveyor 60, and improve the supply capacity per unit time.

In addition, if the tracked goods 2 are located in the area downstream of the above-mentioned rotational direction (the second range C, the third range D), setting the rotational speed to a relatively slower value than the area upstream of the above-mentioned rotational direction (the first range B) can delay the distance between the goods 2 and the holder 51 from becoming wider, and can suppress the expansion of the operation interval for transferring the goods 2 to the conveyor 60.

In addition, it is possible to reliably hold the goods 2 within the outer ring 12 predetermined areas, so that there is no loss of the goods 2, and it is possible to improve the supply capacity per unit time.

In addition, according to the goods alignment supply equipment 1, the rotary alignment apparatus 10 and the conveyor 60 are arranged in close proximity, and the transfer robot 40 is arranged so that the holder 51 can be positioned on the downstream side of the rotational direction of the outer ring 12, which is closer to the imaging unit 31, and on the area where the rotary alignment apparatus 10 and the conveyor 60 are closest to each other.

Due to this configuration, when transferring the goods 2 with the transfer robot 40 from the outer ring 12 to the conveyor 60, it is possible to move the holder 51 along the shortest route, which reduces the time required to transfer the goods 2 and improves the supply capacity of the goods 2 per unit time to the conveyor 60.

In addition, the goods alignment supply equipment 1 is designed with the rotary alignment apparatus 10, the visual sensor 30, the transfer robot 40, and the conveyor 60 arranged in a very compact manner, making it possible to downsize and save space, and making it easy to add to existing factories and existing filling lines, etc.

The above is a detailed explanation of the embodiment of this invention, but the above explanation is merely an example of this invention. It goes without saying that various improvements and changes can be made without deviating from the scope of this invention, and that these are also included within the scope of this invention.

### Description of Reference Signs

1: Goods alignment supply equipment

2: Goods

5: Low Frame

6: Side Frame

7: Upper Frame

10: Rotary alignment apparatus

11: Outer Rotator

12: Outer ring

12a: Fall barrier

12b: Goods loading area

12c: Inclined part

13: Bowl sidewall

13a: Opening

14: Bowl Support

14a: Opening

15: Rotary support

16: Cylinder

17: Gear

18: Servomotor

18a: Servo driver

19: First base

21: Inner Rotator

22: Inner disk

22a: Slide out

23: Shaft part

24: Rotary support

25: Gear

26: Servo motor

26a: Servo driver

27: Second base

28: Accommodation

30: Visual Sensor

31: Imaging unit

32: Image processing unit

40: Transfer robot

41: Base

42: End

43: Link

43a: Upper arm

43b: Parallel arm

43c: Rotary Joint

43d: Spherical joint

43e: Spherical joint

44: Servo motor

44a: Servo driver

45: 1st shaft

46: Servomotor

46a: Servo driver

47: 2nd shaft

48: Servomotor

48a: Servo driver

49: End-effector

49a: Rotary support

51: Holder

51a: Suction box

51b: Adsorption pad

51c: Connector

51d: Attachment part

52: Picking Area

60: Conveyor

61: Servomotor

61a: Servo driver

62: Conveyor part

65: Input device

66: Servomotor

66a: Servo driver

70: Panel PC

71: Server

72: Network

80: Controller

81: Processor

82: Chip set

83: Storage

84: Main memory

85: Upper Network Controller

86: Internal Bus Controller

87: Field Network Controller

88: Network cable

91: Information acquisition part

92: Coordinate transformation part

93: Arc tracking part

94: Rotation speed control part

95: Picking Control Unit

100: Goods alignment supply equipment

200: Rotary alignment apparatus

210: Accommodation

240: Goods loading area

300: Picking robot

400: Conveyor

1. A goods alignment supply equipment comprising:
a rotary alignment apparatus that aligns goods while rotating;
a visual sensor that recognize the goods that have been aligned using the rotary alignment apparatus;
a transfer robot that transfers the goods recognized by the visual sensor to a conveyor; and
a controller that controls rotational alignment operation of the goods by the rotary alignment apparatus and transfer operation of the goods by the transfer robot in an integrated manner, obtaining recognition information for the goods from the visual sensor.

2. The goods alignment supply equipment according to claim 1, wherein the goods alignment supply equipment comprises:
a input device that input the goods to the rotary alignment apparatus; and
the controller that controls rotational alignment operation of the goods by the rotary alignment apparatus and input operation of the goods by the input device in an integrated manner.

3. The goods alignment supply equipment according to claim 1, wherein the goods alignment supply equipment comprises:
the controller that controls transfer operation of the goods by the transfer robot and conveyance operation of the goods by the conveyor in an integrated manner.

4. The goods alignment supply equipment according to claim 1, wherein the goods alignment supply equipment comprises:
the rotary alignment apparatus comprises:
a outer rotator having outer ring on which the goods can be placed side by side in the direction of rotation;
a inner rotator having inner disk arranged in an inclined posture inside the outer rotator;
the visual sensor having imaging unit for capturing images of a portion area of the outer ring;
the transfer robot having a holder for holding the goods located within a predetermined area of the outer ring;
the controller having the first control that tracking the goods captured by the imaging unit and changing the rotation speed of the outer ring based on the tracking information of the goods in the outer ring, and the second control that tracking the goods at the outer ring in response to the first control, and controlling the operation of holding the goods located within the predetermined area of the outer ring by the holder.

5. The goods alignment supply equipment according to claim 4, wherein the predetermined area of the outer ring is divided into multiple areas in the direction of rotation, and the controller, in the first control, determines in which of the multiple areas the tracked goods is located, and controls the switching of the rotation speed of the outer ring according to the determination.

6. The goods alignment supply equipment according to claim 5, wherein the controller, in the first control, switches the rotation speed of the outer ring so that, of the multiple areas, the area upstream of the rotation direction has a higher rotation speed than the area downstream of the rotation direction.

7. The goods alignment supply equipment according to claim 4, wherein the rotary alignment apparatus and the conveyor are located in close proximity to each other, the transfer robot is arranged so that the holder can be positioned downstream of the imaging unit in the direction of rotation of the outer ring and on the area where the rotary alignment apparatus and the conveyor are closest to each other.

8. A goods alignment supply method, wherein
a rotary alignment apparatus aligns the goods in the direction of rotation while rotating them;
a visual sensor recognize the goods that have been aligned using the rotary alignment apparatus;
a transfer robot transfers the goods recognized by the visual sensor to a conveyor; wherein
a controller controls rotational alignment operation of the goods by the rotary alignment apparatus and transfer operation of the goods by the transfer robot in an integrated manner, obtaining recognition information for the goods from the visual sensor.

9. A goods alignment supply method according to claim 8, wherein the controller controls rotational alignment operation of the goods by the rotary alignment apparatus and input operation of the goods by a input device that input the goods to the rotary alignment apparatus in an integrated manner.

10. A goods alignment supply method according to claim 8, wherein the controller controls transfer operation of the goods by the transfer robot and conveyance operation of the goods by the conveyor in an integrated manner.

11. The goods alignment supply method according to claim 8, wherein the goods alignment supply method comprises:
the rotary alignment apparatus comprises:
a outer rotator having outer ring on which the goods can be placed side by side in the direction of rotation;
a inner rotator having inner disk arranged in an inclined posture inside the outer rotator;
the visual sensor having imaging unit for capturing images of a portion area of the outer ring;
the transfer robot having a holder for holding the goods located within a predetermined area of the outer ring;
the controller implement the first control that tracking the goods captured by the imaging unit and changing the rotation speed of the outer ring based on the tracking information of the goods in the outer ring, and the second control that tracking the goods at the outer ring in response to the first control, and controlling the operation of holding the goods located within the predetermined area of the outer ring by the holder.

12. The goods alignment supply method according to claim 11, wherein the predetermined area of the outer ring is divided into multiple areas in the direction of rotation, and the controller, in the first control, determines in which of the multiple areas the tracked goods is located, and controls the switching of the rotation speed of the outer ring according to the determination.

13. The goods alignment supply method according to claim 12, wherein the controller, in the first control, switches the rotation speed of the outer ring so that, of the multiple areas, the area upstream of the rotation direction has a higher rotation speed than the area downstream of the rotation direction.
